(19) United States
(12) Patent Application Publication
(10) Pub. No.: US 2013/0180914 A1
(43) Pub. Date: Jul. 18, 2013

(54) Long-term Sequestration of Uranium in Iron-Rich and Iron-Enriched Sediment

(71) Applicants: Wei-Min Wu, Okemos, MI (US); Xin Du, Chicago, IL (US); Craig S. Criddle, Redwood City, CA (US)

(72) Inventors: Wei-Min Wu, Okemos, MI (US); Xin Du, Chicago, IL (US); Craig S. Criddle, Redwood City, CA (US)

(21) Appl. No.: 13/529,811

(22) Filed: Jun. 21, 2012

Related U.S. Application Data
(63) Continuation-in-part of application No. 13/317,807, filed on Oct. 28, 2011, now abandoned.
(60) Provisional application No. 61/455,898, filed on Oct. 28, 2010.

(51) Int. Cl. B09C 1/00

(52) U.S. Cl. CPC B09C 1/002
USPC 210/610; 210/747.8

(57) ABSTRACT

In situ formation of U(VI)-Fe(III) oxides and hydroxides can provide effective uranium remediation. The reason for this is that such compounds can effectively sequester uranium, even in the (VI) oxidation state. Such compounds can be formed in situ by 1) providing Fe(II), 2) reducing uranium to U(IV), and 3) oxidizing the resulting mixture to provide the desired U(VI)-Fe(III) oxides and hydroxides.

### CROSS REFERENCE TO RELATED APPLICATIONS

This application is a continuation in part of U.S. application Ser. No. 13/317,807, filed Oct. 28, 2011, entitled “Long-Term Sequestration of Uranium in Iron-Rich Sediment”, and hereby incorporated by reference in its entirety. Application Ser. No. 13/317,807 claims the benefit of U.S. provisional patent application 61/455,898, filed on Oct. 28, 2010, entitled “Long-Term Sequestration of Uranium in Iron-Rich Sediment”, and hereby incorporated by reference in its entirety.

### GOVERNMENT SPONSORSHIP

This invention was made with Government support under contract number DE-SC0006783 awarded by the Department of Energy. The Government has certain rights in this invention.

### FIELD OF THE INVENTION

This invention relates to in situ remediation of uranium.

### BACKGROUND

Uranium commonly has two oxidation states: U(IV) and U(VI). It is known that U(IV) compounds tend to have low U solubility in typical groundwater environments, so they are suitable for in situ U sequestration. U(VI) compounds tend to have high U solubility in typical groundwater environments. Thus, conventional U sequestration approaches often rely on reducing U to U(IV) combined with preventing the subsequent formation of U(VI). Unfortunately, it is difficult to prevent U(VI) formation in practice. Various approaches have been employed to provide a long-term reducing environment (which would prevent U(VI) formation), but such approaches tend to have significant practical issues relating to effectiveness over the long term. Accordingly, it would be an advance in the art to provide an improved approach for uranium sequestration.

### SUMMARY

We have unexpectedly found that U(VI)-Fe(III) oxides and hydroxides tend to have low U solubility in typical groundwater environments. Thus, in situ formation of such compounds is an attractive approach for in-situ Uranium remediation. To better appreciate the present approach, it is helpful to refer to FIG. 1, which shows a simplified diagram of the relevant iron-uranium chemistry.

Uranium remediation is mainly focused on removing mobile U(VI) complexes (102) from a remediation location. As indicated above, the main discovery of the present invention is that U(VI)-Fe(III) oxides and/or hydroxides stable at high pe (114) can provide uranium sequestration. Thus, to the best of our knowledge, the existence of compounds 114 (enclosed with a dashed line on FIG. 1) has not been appreciated in the art. In practice, a uranium remediation process according to these principles entails moving from compounds 102 to compounds 114 on FIG. 1. There are several ways this can be done, which can be better appreciated by brief consideration of the various processes shown on FIG. 1.

Processes 122 include any oxidation/reduction processes for uranium that do not involve iron. Examples include abiotic and biotic uranium oxidation and reduction. These oxidation/reduction reactions relate to the U(VI) species 102 and U(IV) species 110. As indicated on FIG. 1, U(IV) species tend to be stable at low pe.

Processes 124 and 126 are more significant for the present approach, since they relate to oxidation and reduction in the iron/uranium system (or any systems including both iron and uranium). These processes can occur biotically and/or abiotically. Process 124 is the oxidation of uranium from U(IV) to U(VI) (110 to 102 on FIG. 1) combined with the reduction of iron from Fe(III) to Fe(II) (106 to 104 on FIG. 1). Process 126 is the reduction of uranium from U(VI) to U(IV) (102 to 110 on FIG. 1) combined with the oxidation of iron from Fe(II) to Fe(III) (104 to 106 on FIG. 1). In theory, one could perform uranium remediation with process 126 alone, since the resulting U(IV) compounds are sparingly soluble and would provide sufficient sequestration. However, if the environment of the remediation location becomes oxidizing after this simple sequestration is performed, the reverse reaction 124 would take place, which would undesirably liberate the mobile U(VI) complexes 102. Chemical reactions are most often reversible as in the example of processes 124 and 126 on FIG. 1, while effective sequestration relies on finding a process that is effectively “one way”. Thus sequestration typically depends in unexpected ways on specific details of the relevant chemistry.

In practice, there may also be iron oxidation/reduction processes 128 that do not relate directly to uranium. As above, both abiotic and biotic processes may be relevant here.

Another set of reversible processes relates to sorbed U(VI) on Fe(III) oxides (i.e., compounds 108). Sorption is a physical process (as opposed to a process that forms or alters chemical bonds). Processes 132 and 134 relate compound 108 to compounds 102 and 106, and are shown with double-headed arrows to indicate their reversibility. Another relevant process here is process 130, where desorption of U(VI) is combined with reduction of iron to the Fe(II) oxidation state. As above, these processes can occur abiotically or biotically. Sorbed U(VI) on Fe(III) oxides is not a suitable end point for a uranium sequestration process because reverse reactions that provide mobile U(VI) 102 are unavoidable.

Compounds having U(IV)/U(VI) combined with Fe(III) (i.e., compounds 112 on FIG. 1) are important intermediates. They can arise from U(IV) compounds 110 and Fe(III) oxides 106 as indicated schematically by processes 136.

The most significant processes shown on FIG. 1 are processes 138, 140 and 142, which all lead to formation of the desired U(VI)-Fe(III) oxides and/or hydroxides stable at high pe (i.e., compounds 114). We have found that these processes tend to be one-way processes, such that undesirable reverse reactions that can liberate uranium from the U(VI)-Fe(III) oxides and/or hydroxides tend not to occur (or occur with negligible rate). The results of part C below provide an experimental demonstration of this point.

### BRIEF DESCRIPTION OF THE DRAWINGS

FIG. 1 is a simplified diagram of uranium-iron chemistry.

FIGS. 2a-b show examples of remediation according to principles of the invention.

FIG. 3 shows an example of a nano-particle for providing iron to a uranium remediation location.

FIGS. 4a-d show predicted relative abundances of U(VI) and Fe(II) in the iron-uranium and iron-uranium-carbonate systems.

FIGS. 5a-e show comparison of experimental results to computed AG values for Fe(II) reduction of U(VI).

FIGS. 6a-d show kinetics of uranium (VI) reduction in the iron-uranium and iron-uranium-carbonate systems.

FIG. 7 is a diagram of pe-pH in the iron-uranium system for Fe(II)/Fe(III) and U(IV)/U(VI).

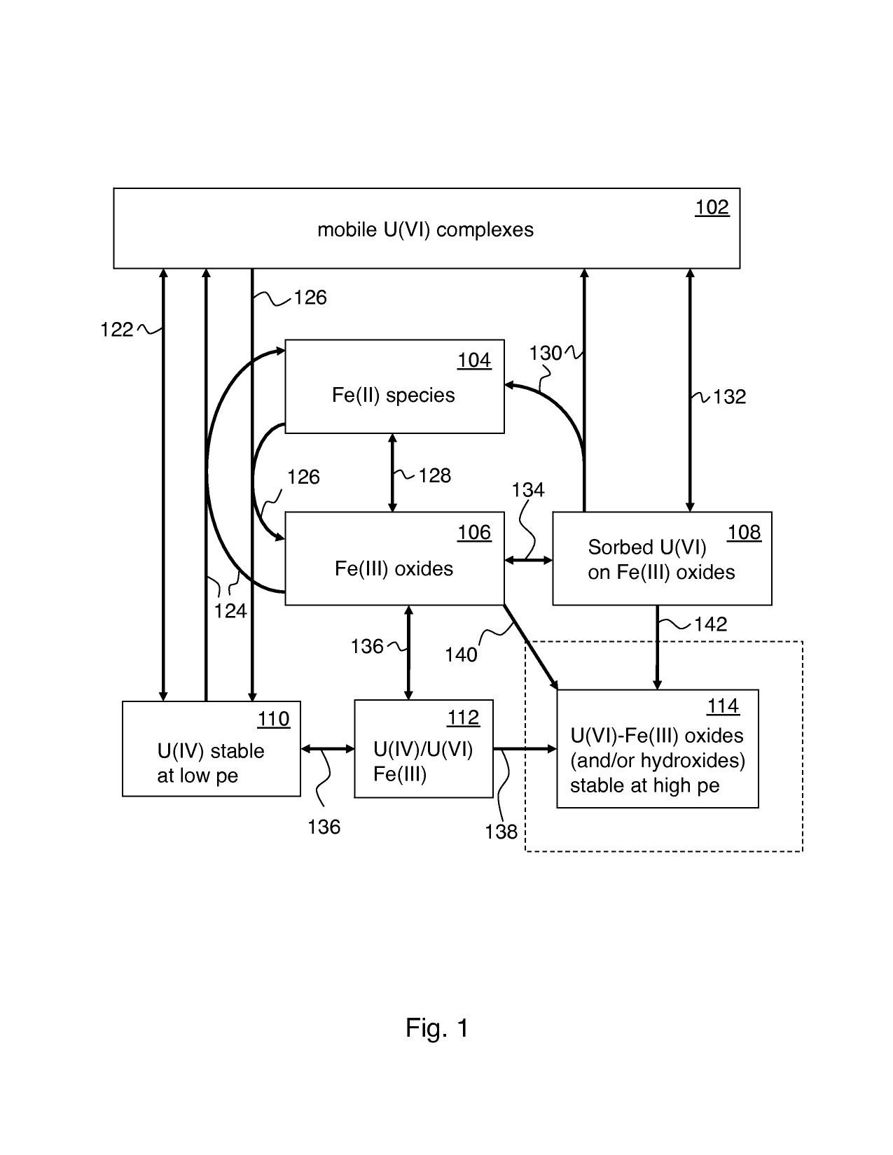

### DETAILED DESCRIPTION

### A) Description of Embodiments

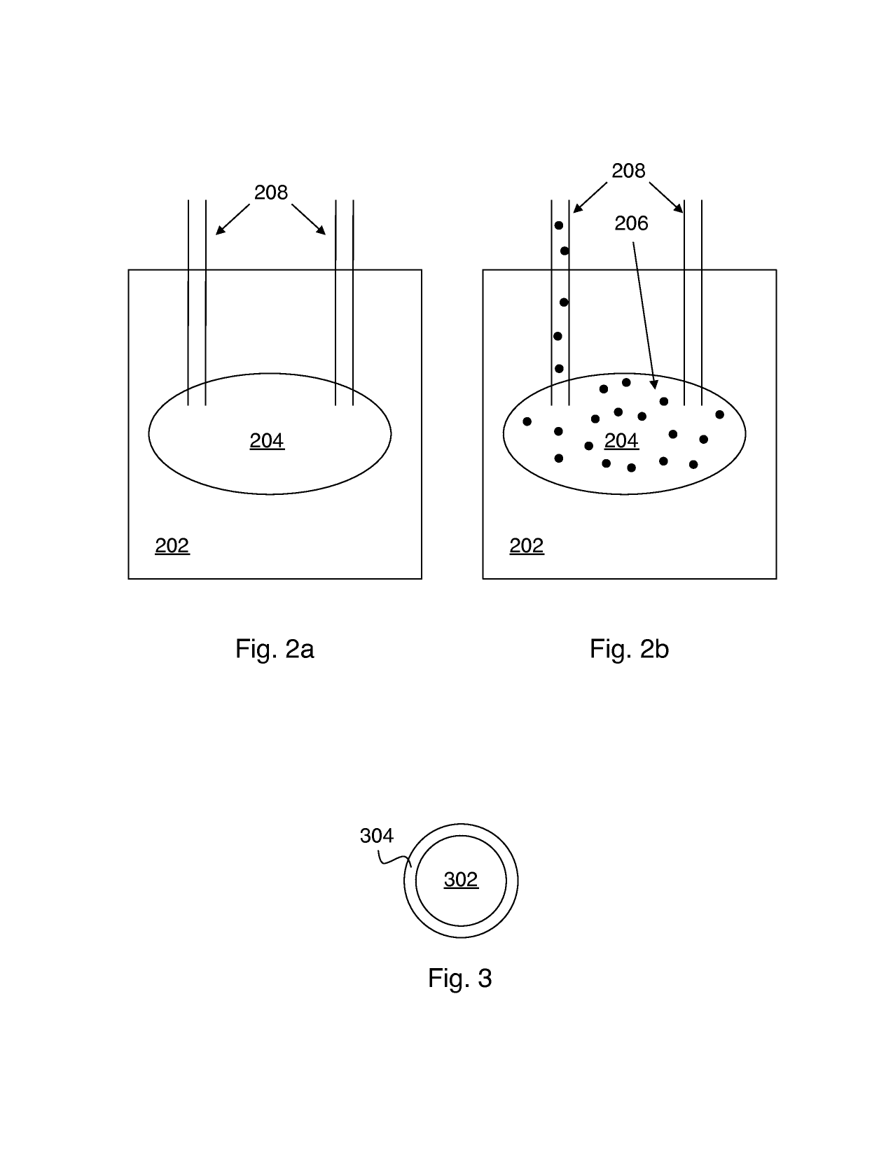

FIGS. 2a-b show use of some embodiments of the invention. Here 204 is an underground remediation location in earth 202. Pipes 208 can be employed to provide compounds to the remediation location 204. Practice of the invention does not depend critically on how reagents are provided to the remediation location. One exemplary method is as follows:

1) Add ferrous (Fe(II)) iron to an in situ remediation location (e.g., 204 on FIG. 2a) having uranium in need of remediation.
2) Increase the pH of the in situ remediation location to reduce the uranium to the U(IV) oxidation state.
3) Provide oxidants such that the iron is oxidized to the Fe(III) oxidation state and the uranium is oxidized to the U(VI) oxidation state, and such that a sparingly soluble U(VI)-Fe(III) oxide or hydroxide is formed. We expect that the sequence of oxidation of U(IV) and Fe(II) could vary and would depend upon the relative ease of access of the oxidant to the U(IV) and Fe(II), the nature of the oxidant (oxygen, nitrate), and whether the mechanism is abiotic or biotic. Furthermore, it is not important that the U(IV) be completely oxidized to U(VI). Any U(IV) that remains will be sparingly soluble, and thus effectively sequestered.

Step 1 above is optional, and can be omitted if sufficient Fe(II) is already present at the remediation site. If Fe(II) is to be added, this can be done in various ways, such as using a solution of an Fe(II) compound, the use of Fe(III) respiring bacteria (which provide Fe(II) as a metabolism product), and nanoparticles containing Fe(II). If bacteria are employed, they can be provided to the remediation site or they may naturally be present at the remediation site. Nanoparticles can provide an attractive way to distribute Fe(II) at the remediation location. FIG. 2b shows an example of this approach, where nanoparticles are referenced as 206.

If nanoparticles are employed, they can include elemental iron and/or Fe(II) iron compound(s). Nanoparticles can be coated (e.g., as shown on FIG. 3), where a coating 304 covers a core 302. Core 302 includes elemental iron and/or Fe(II) iron compound(s). The coating preferably dissolves or degrades in situ at the remediation location to release the core contents. Elemental iron is an especially interesting core material because liberating it at the remediation location simultaneously provides Fe(II) and oxidizes U(VI) to U(IV), thereby efficiently performing two important steps simultaneously.

Step 2 can be performed in various ways. The reduction to U(IV) can be partial (50-90%) or substantially complete (>90%). In cases where the Ca concentration in groundwater is high, U(VI) may only be partially reduced to U(IV) by Fe(II). Various methods can be employed to raise the pH. The pH can be raised by releasing elemental iron in the remediation location, so that uranium is reduced to the U(IV) oxidation state by hydrogen released in the Fe+2H₂O->Fe(II)+H₂+2OH⁻ reaction. Alternatively, the pH can be raised by providing MgO to the remediation location, so that the pH is raised by the MgO+H₂0->Mg(OH)₂ reaction. As a further alternative, the pH can be raised by providing a carbonate solution to the remediation location.

Step 3 above is optional, because in some cases a sufficient supply of oxidants is naturally present at the remediation location to form the U(VI)-Fe(III) oxides or hydroxides. Thus, natural oxidation processes of the remediation location can provide the sparingly soluble U(VI)-Fe(III) oxide or hydroxide in situ. If oxidants are added to the remediation site, this can be done in various ways, such as providing one or more of: O₂, H₂O₂, NO₃⁻ ions, NO₂⁻ ions, nitrous oxide, bleach, etc.

### B) U—Fe Thermodynamics

### B1) Introduction

Mining and refining of uranium for weapons and fuel have led to widespread groundwater contamination, and the challenge of protecting groundwater resources from uranium contamination is likely to grow; a 2008 forecast of global uranium production (existing, committed, planned, and prospective) projected a ˜40% increase between 2010 and 2020, from 86,720 tonnes/year to 122,620 tonnes/year. Because uranium is both toxic and bioaccumulative, strategies are needed to decrease its bioavailability and to prevent its transport in water. In oxidizing environments, uranium exists primarily as hydroxyl and carbonate complexes of uranyl, either dissolved in solution or adsorbed to surfaces, and as precipitated mineral phases. In reducing environments, U exists as sparingly soluble forms, such as uraninite (UO₂).

Bioremediation of soluble U(VI) by reduction to sparingly soluble U(IV) was first proposed in the early 1990s and subsequently tested under field conditions. Bacteria that reduce U(VI) include dissimilatory iron-reducing bacteria (DIRB), such as Shewanella sp., Geobacter spp., Anaeromyxobacter spp., various Clostridia, and sulfate-reducing bacteria (SRB), such as Desulfovibrio spp. and Desulfosporosinus spp. SRB and DIRB also mediate indirect uranium(VI) reduction via sulfide and Fe(II) species, respectively. U(VI) reduction by hydrogen sulfide can explain the observed rates of U(VI) reduction for Desulfovibrio aerotolerans, a SRB isolated from a U(VI)-contaminated site. Many U-contaminated sediments are rich in iron, and iron can significantly impact U mobility. Ferrous iron solids known to reduce U(VI) include mixed Fe(II)-Fe(III) green rust, FeS minerals, siderite, and magnetite. X-ray photoelectron spectroscopy (XPS) studies have shown that FeS and magnetite reduce U(VI) to UO₂, U₃O₈, and U₄O₉.

In this work, we focus on the capacity for soluble Fe(II) species to reduce soluble U(VI) species. Solution chemistry controls the direction of these electron transfer reactions. At pH 7 and U(VI) and Fe(II) concentrations of 2×10⁻⁶ and 5×10⁻⁷ M, respectively, the Fe(III)/Fe(II) and U(VI)/U(IV) couples have similar reduction potentials. Small changes in solution chemistry reverse the direction of coupled reactions, switching iron species from U(VI) reductants to U(IV) oxidants. While high levels of carbonate favor formation of soluble uranyl carbonate complexes, a fact exploited for in situ leach mining of uranium, they also change the reduction potentials of Fe(III)/Fe(II) and U(VI)/U(IV) couples, facilitating Fe(III) oxidation of U(IV). Studies that use high levels of carbonate to extract U(VI) from a solid sample containing Fe(III) thus likely also measure U(IV). This is important for experiments designed to evaluate Fe(II) reduction of U(VI), where the reaction products are Fe(III) and U(IV) species. In the present work, we evaluated U(VI) reduction in two well-defined reaction systems, an iron-uranium (IU) system and an iron-uranium-carbonate (IUC) system, and we avoided use of carbonate extraction. Contrary to an earlier report in the literature (Liger et al., “Surface catalysis of uranium (VI) reduction by iron (II)”, Geochim. Cosmochim. Acta. 1999, 63, 2939-2955, hereby incorporated by reference in its entirety), we find that the U—Fe system is under classical thermodynamic control with rapid reduction of soluble U(VI) by soluble Fe(II) species when thermodynamic conditions are favorable.

### B2) Materials And Methods

Stock Solutions.

Stock solutions were prepared in 160 mL anaerobic serum bottles with oxygen-free water under a helium headspace, using analytical-grade chemicals or better: UO₂Cl₂, 10 mM; FeCl₂, 20 mM; NaHCO₃, 1 M; HCl, 0.5 M; NaOH, 0.2 M. All experiments were carried out in an anaerobic glovebox (Coy Laboratory Products Inc.) containing a He headspace. Iron(II) chloride tetrahydrate (99.99%) purity purchased from Sigma-Aldrich was used for preparation of stock solutions. Uranyl chloride was obtained from Johnson Matthey, Ward Hill, Mass.

Uranium(VI) Reduction in the Iron-Uranium (IU) System.

Serum bottles sealed with butyl rubber stoppers were prepared with 90 mL of helium-sparged oxygen-free deionized water under a helium headspace and stored inside an anaerobic glove-box containing a helium atmosphere. The following volumes of stock solutions were added: 2 mL of the UO₂Cl₂ stock, 5 mL of the FeCl₂ stock, and 1 mL of the HCl stock. Samples were withdrawn by syringe for measurement of initial concentrations of Fe(II) and U(VI). The measured initial values were 1.0 mM for Fe(II) and 0.21 mM for U(VI). Initial solution pH was then increased in a stepwise manner by adding defined aliquots (0.02-0.5 mL) of NaOH stock. After each addition and mixing, a sample was extracted by syringe and transferred to a plastic screw-cap anaerobic centrifuge tube and the pH measured. The pH range was 2.36-10.77. Duplicate samples were prepared at each pH level. At pH>8, a green precipitate appeared and bottles were shaken well to obtain a well-mixed sample.

After collection of 14 samples, each at progressively higher pH levels, samples were centrifuged for 4 min at 1400 rpm in a glovebox. Centrate was removed by pipet and transferred to glass tubes containing 10 mL of anaerobic acidifed deionized water (pH 2.1) and then assayed for Fe(II) and U(VI). One sample with an initial pH of 6.52 (5.45 after reaction) was stored for analysis by X-ray adsorption near-edge structure (XANES) spectroscopy. Solids from another sample at the highest pH level (10.77), with no U(VI) in solution, were transferred to a plastic screw-cap anaerobic centrifuge tube, sealed, and stored inside a second anaerobic bottle for XANES analysis.

Uranium(VI) Reduction in the Iron-Uranium-Carbonate (IUC) System.

The same procedure described above was employed for the IUC system except a syringe was used to add 0.5 mL of NaHCO₃ stock solution to the initial mixture. The pH range was 2.42-0.73. All samples were prepared in duplicate at each pH level. One sample with an initial pH of 6.39 (6.28 after reaction) was stored for analysis by XANES spectroscopy.

As before, when a green precipitate appeared (pH>6), the serum bottles were shaken well to ensure a well-mixed sample. After collection of 19 samples, each at a progressively higher pH level, all samples were centrifuged for 4 min at 1400 rpm in the glovebox. Centrate was transferred by pipet to glass tubes containing 10 mL of anaerobic acidifed deionized water (pH 2.1) for measurement of Fe(II) and U(VI). After measurement of aqueous U(VI) concentrations at each pH level, solids from the sample at pH 10.73 (no U(VI) in solution) were transferred to a plastic screw-cap anaerobic centrifuge tube, sealed, and stored inside a second anaerobic bottle for XANES spectroscopic analysis.

Kinetic Measurements of Uranium Reduction.

To assess the kinetics of U(VI) reduction, solution pH was adjusted from 2.40 to 4.10, 6.19, and 8.79 in the IU system and from 2.40 to 4.03, 6.22, and 8.93 in the IUC system. For both systems, the initial pH of ˜2.4 resulted from addition of 1 mM ferrous iron and 0.2 mM U(VI). The IUC system also contained 5 mM NaHCO₃. Samples for U(VI) measurement were prepared as described above.

Analytical Methods.

Soluble U(VI) was assayed by spectro-fluorometry after correcting for Fe(II) quenching. Centrate from centrifuged samples was transferred to glass tubes containing 10 mL of anaerobic acidifed deionized water (pH 2.1) and assayed for Fe(II). U(VI) standard curves were prepared at the same pH and levels of Fe(II) measured in the centrate. Sample unknowns and standards were transferred to cuvettes, supplemented with Uraplex (Chemcheck Instruments, Richland, Wash.), and assayed for U(VI) on a spectrofluorometer (Jobin Yvon, Inc., Edison, N.J.) at wavelengths of 515.4 nm in emission acquisition mode and 280.0 nm in excitation acquisition mode. The U(VI) detection limit was 0.01 mg/L. Method accuracy was confirmed with a TJA IRIS Advantage/1000 Radial ICAP inductively coupled plasma optical emission spectrometer (ICP-OES) equipped with a solid state CID detector. The ICP-OES uses three wavelengths to measure fluorescence, enabling compensation for quenching, but was less sensitive (110 ppb vs. <10 ppb for the fluorescence method) and less convenient for monitoring of time series.

Select samples were collected for analysis by XANES spectroscopy at the Stanford Synchrotron Radiation Laboratory. Wet sample pellets were loaded into an aluminum sample holder in an anaerobic chamber (helium atmosphere). Fluorescence U L-III edge XANES spectra were collected at 77 K on beam line 10-2 using a Si(220) double-crystal monochromator, detuned to attenuate harmonic content in the beam. Beam size was set to 1 mm vertical 3 mm horizontal. Data were corrected for background and normalized using the software SIXPACK (Version, 0.63). Uranyl nitrate (UO₂ (NO₃)₂) was used as a standard for U(VI) and stoichiometric UO_{2.00} for U(IV). Linear combination fits in SIXPACK using model compounds were used to determine U(VI) and U(IV) proportions. Sensitivity to oxidation state is based on the energy position of the X-ray absorption edge (relatively shift for U(VI)) and by the presence or absence of the strong multiple-scattering peak at ca. 17,185 eV, characteristic of the uranyl trans-dioxo cation. XANES spectra of both samples were best fit as a linear combination of U(IV) and U(VI) standards.

Thermodynamic Calculations.

Overall potentials for coupled reactions were computed by combining half reactions for oxidized uranium species present at each pH with the appropriate half reactions for aqueous Fe(II), ferrous hydroxide, or siderite. Gibbs free energy of formation data were obtained from the literature for the following species: uranium species; iron oxides; ferrihydrite (Fe(OH)₃.nH₂O), and siderite (FeCO₂). U(IV) was assumed to be present as amorphous UO₂. Visual MINTEQ (Version 2.53) was used to determine speciation in the aqueous and solid phases, and graphs of thermodynamic feasibility were calculated and produced using Matlab® (Version 6.5).

Table 1 summarizes stoichiometric coefficients for U(VI) half reaction reduction equations and corresponding standard Gibbs free energy values in the IU system. Twelve U(VI) species were evaluated over the pH range 3.5-10. Reduction reactions were computed for half reactions written in an acidic or a basic form

aU(VI)+bH⁺+e⁻→½UO₂(am,hyd)+bH₂O(acidic form)

aU(VI)+e⁻→½UO₂(am,hyd)+bOH⁻(basic form)

where a and b are the stoichiometric coefficients needed to balance the half reactions. For the iron-uranium-carbonate (IUC) system, five uranyl carbonate species were included: (UO₂CO₃, (UO₂)₂CO₃(OH)₃⁻, UO₂(CO₃)₂²⁻, UO₂(CO₃)₃⁴⁻, and (UO₂)₃(CO₃)₆⁶⁻).

TABLE 1
Stoichiometric coefficients for uranium half
reactions in the IU system and corresponding changes in
Standard Gibbs Free Energy.

| | Stoichiometric | | ΔGᵣ° (kJ/mol) value | |
|---|---|---|---|---|
| | coefficients | | Acidic | |
| Species | a | b | form | Basic form |
| UO₂²⁺ | 1/2 | 0 | −21.50 | −21.50 |
| UO₂OH⁺ | 1/2 | 1/2 | −36.49 | −3.48 |
| (UO₂)₂(OH)₂²⁺ | 1/4 | 1/2 | −29.52 | 10.44 |
| (UO₂)₂OH³⁺ | 1/4 | 1/4 | −25.35 | −5.37 |
| UO₂Cl⁺ | 1/2 | 0 | −21.01 | −21.01 |
| (UO₂)₃(OH)₅⁺ | 1/6 | 5/6 | −36.29 | 30.30 |
| (UO₂)₄(OH)₇⁺ | 1/8 | 7/8 | −37.13 | 32.80 |
| (UO₂)₃(OH)₄²⁺ | 1/6 | 2/3 | −32.82 | 20.46 |
| UO₂(OH)₂(aq) | 1/2 | 1 | −56.18 | 23.74 |
| (UO₂)₃(OH)₇⁻ | 1/6 | 7/6 | −52.13 | 41.11 |
| UO₂(OH)₃⁻ | 1/2 | 3/2 | −79.29 | 40.59 |
| UO₂(OH)₄²⁻ | 1/2 | 2 | −113.97 | 45.87 |

Table 2 lists half reactions and standard Gibbs free energy of formation values for two potentially dominant electron donors in the IU system, Fe2⁺ and Fe(OH)₂.

TABLE 2
Half reactions of the dominant electron donors in
the IU system.

| | | Half Reaction of the | |
|---|---|---|---|
| | | Electron Donor | ΔGᵣ° (kJ/mol) |
| Aqueous | Acidic | Fe²⁺ + 3H₂O → Fe(OH)₃ + 3H⁺ + e⁻ | 81.72 |
| Phase | form | | |
| | Basic | Fe²⁺ + 3OH⁻ → Fe(OH)₃ + e⁻ | −158.04 |
| | form | | |
| Solid | Acidic | NA | NA |
| Phase | form | | |
| | Basic | Fe(OH)₂ + OH⁻ → Fe(OH)₃ + e⁻ | −65.28 |
| | form | | |

### B3) Results

Gibbs Free Energy of Formation for Half Reactions.

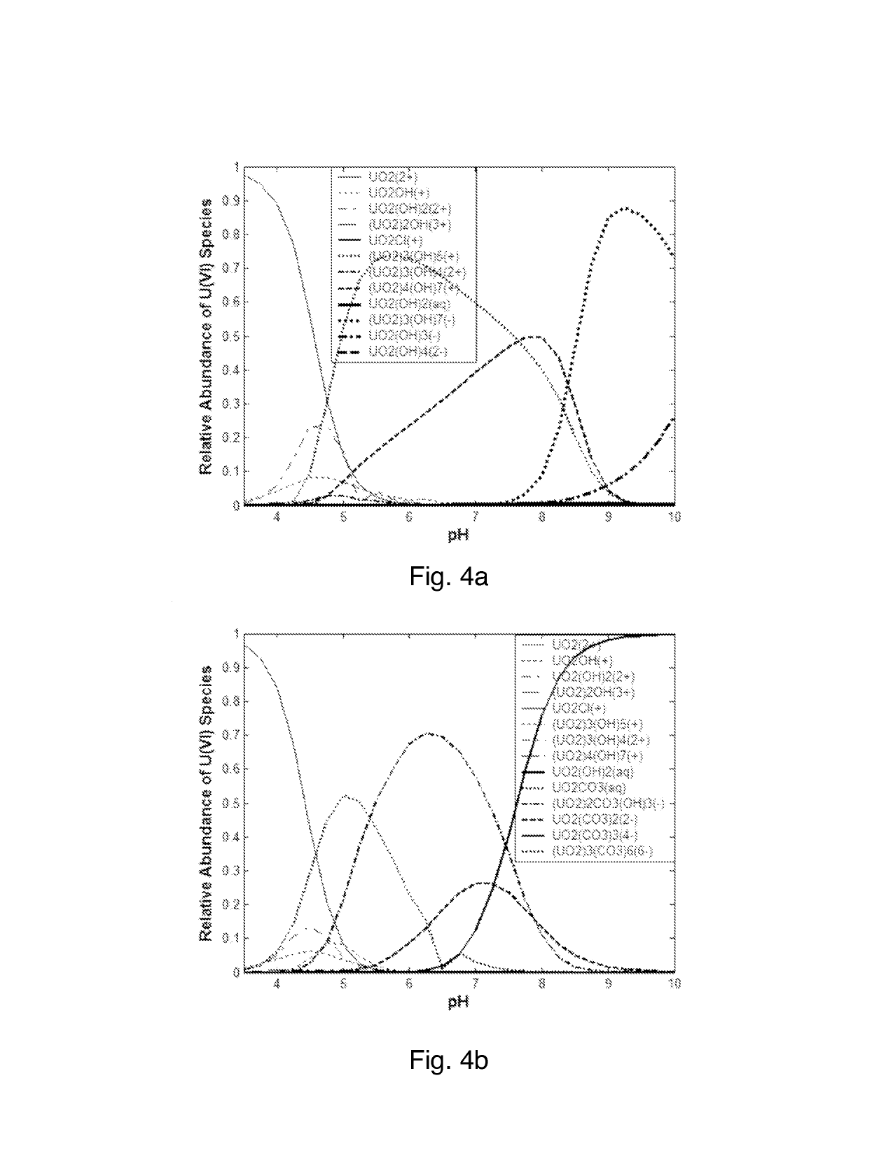

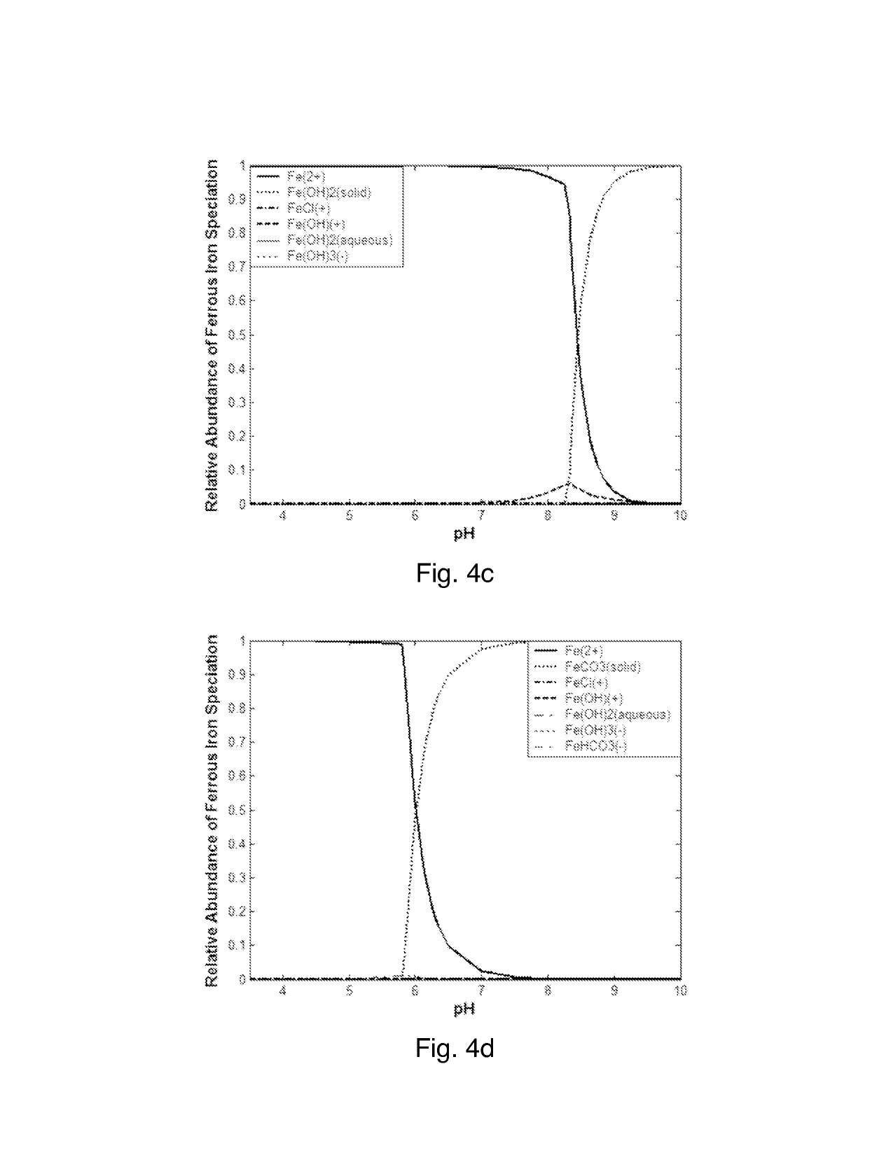

FIGS. 4a-d illustrates the expected relative abundance of uranium and iron species in both systems at equilibrium for the pH range 3.5-10 (total U(VI) concentration=0.2 mM, total Fe(II) concentration=1 mM). Here FIG. 4a relates to U(VI) speciation in the IU system, FIG. 4b relates to U(VI) speciation in the IUC system, FIG. 4c relates to Fe(II) speciation in the IU system, and FIG. 4b relates to Fe(II) speciation in the IUC system. As pH increases in the IU system, equilibrium calculations predict increasing hydroxyl ligand substitution in the uranyl complex, with UO₂²⁺, (UO₂)₃(OH)₅⁺, (UO₂)₄(OH)₇⁺, (UO₂)₃(OH)₇, becoming sequentially dominant. For the IUC system, a pH increase leads to increasing carbonate ligand substitution, with UO₂²⁺, UO₂CO₃(aq) (UO₂)₂CO₃(OH)₃ and (UO₂)(CO₃)₃⁴⁻ becoming sequentially dominant. Above pH 8.5, nearly all of the U(VI) is present as the tricarbonate complex (UO₂ (CO₃)₃⁴).

Thermodynamic Calculations and Experimental Data.

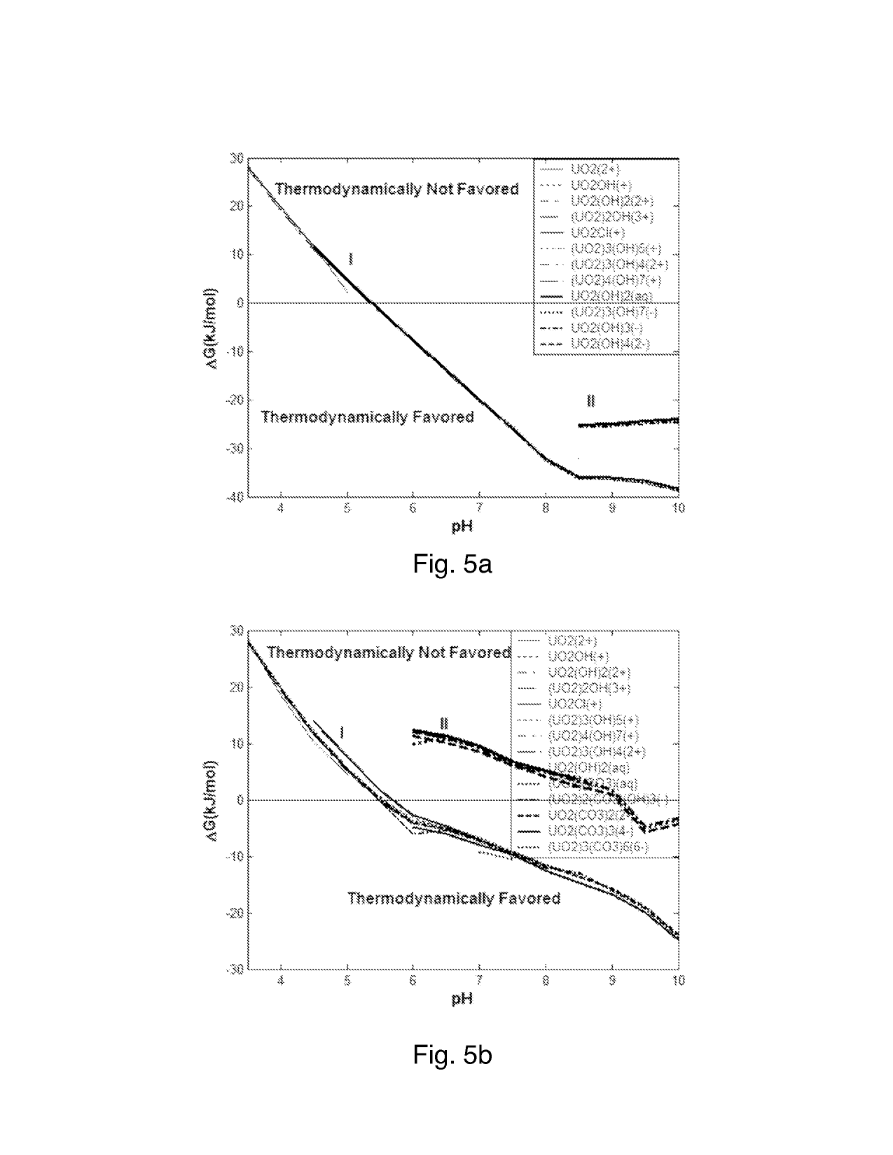

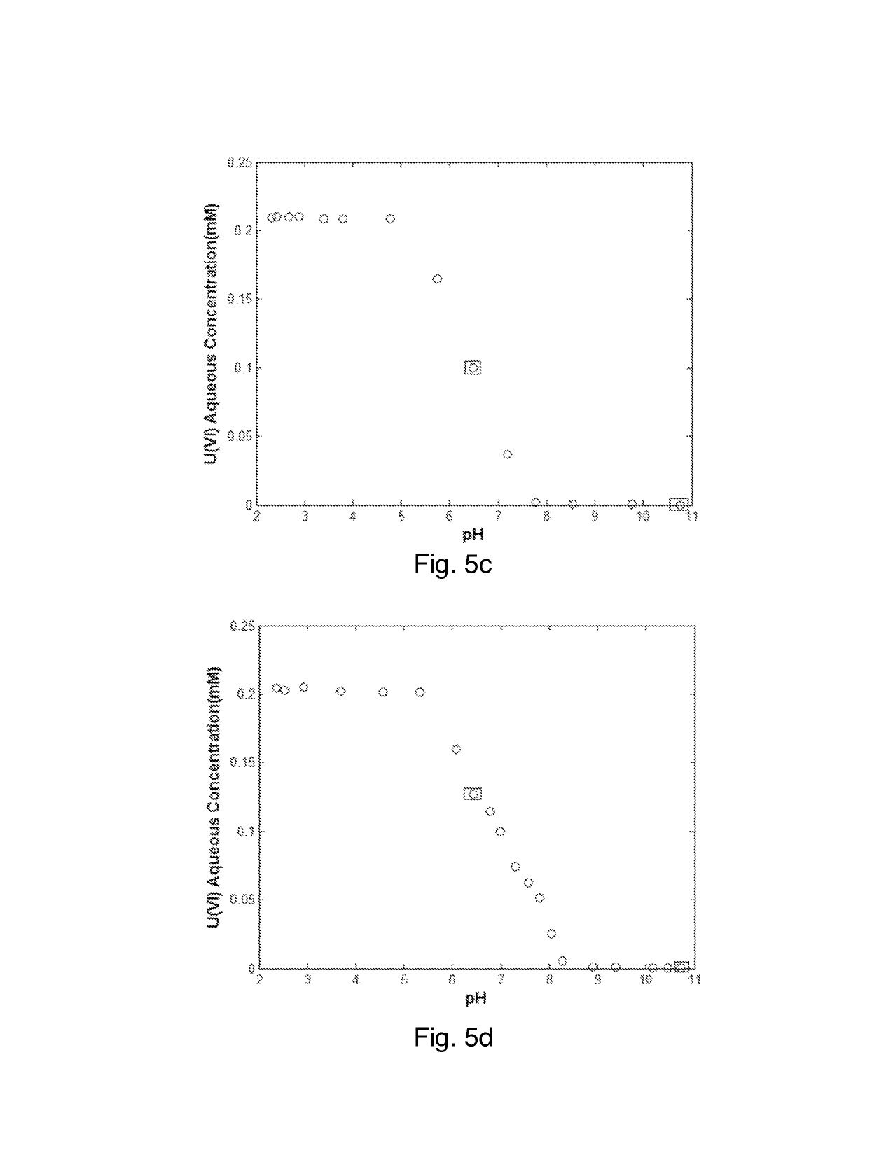

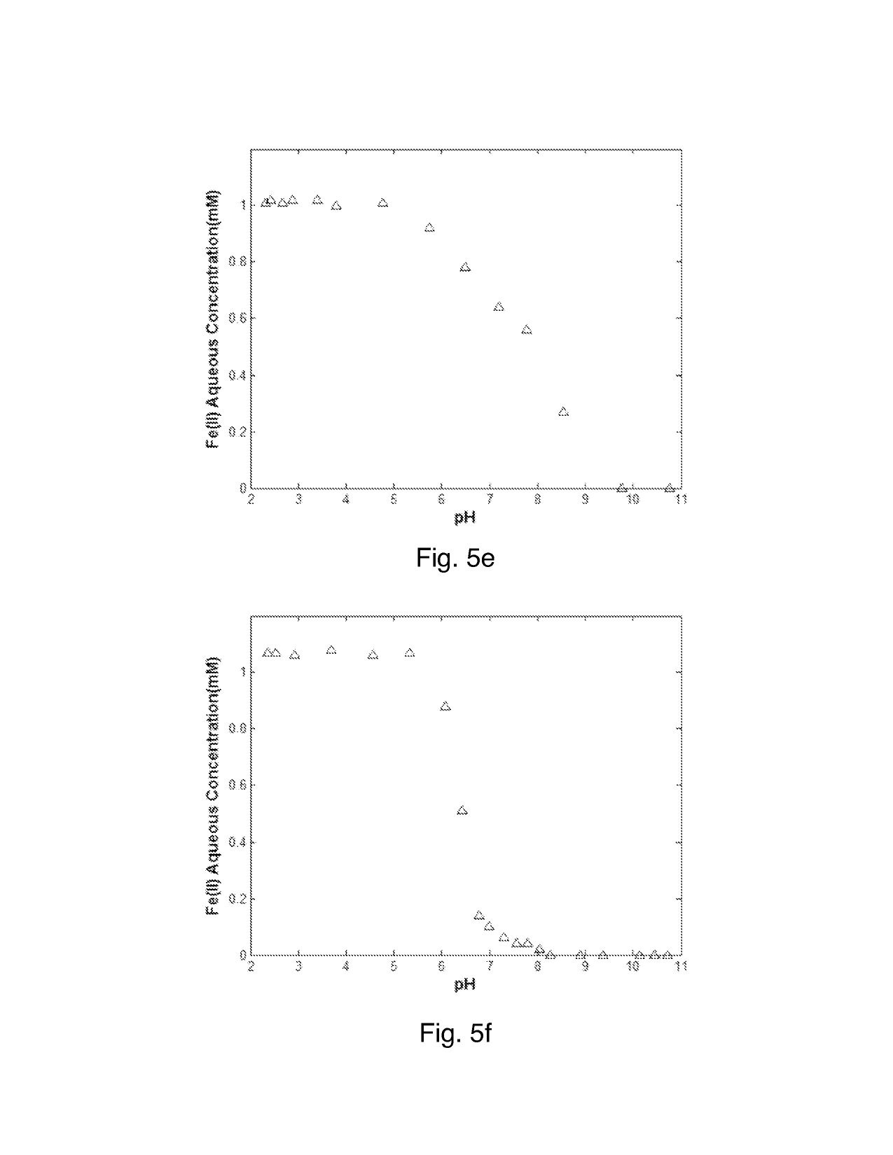

FIGS. 5a-b illustrate changes in Gibbs free energy for Fe(II) reduction of U(VI) species as a function of pH (concentrations of U(VI) and Fe(II) are 0.2 mM and 1 mM respectively). On FIG. 5a, line I relates to U(VI) reduction by Fe²⁺(aq) and line II relates to U(VI) reduction by Fe(OH)₂. On FIG. 5b, line I relates to U(VI) reduction by Fe²⁺(aq) and line II relates to U(VI) reduction by FeCO₃(s). FIG. 5c shows measured U(VI) (aq) in the IU system vs. pH. FIG. 5d shows measured U(VI) (aq) in the IUC system vs. pH. FIG. 5e shows measured Fe²⁺(aq) for each point in FIG. 5c. FIG. 5f shows measured Fe²⁺(aq) for each point in FIG. 5d. XANES spectroscopy was performed on solids from samples enclosed by rectangles on FIGS. 5c-d.

For the IU system, U(VI) reduction and coupled oxidation of soluble Fe(II) was thermodynamically favorable when pH exceeded ˜5.4. At pH values above 8, ferrous hydroxide formed and U(VI) reduction by Fe(OH)₂ became favorable (FIGS. 4c and 5a, curve II). For the IUC system, reduction of U(VI) was favorable when pH exceeded ˜5.5.

XANES analyses of collected precipitate confirmed reduction of U(VI) to U(IV) (Table 3). This conclusion was confirmed by reaction stoichiometry, with soluble Fe(II) reacting with U(VI) in a molar ratio of ˜2:1 (Table 4). This ratio increased at higher pH levels, likely due to removal of U(VI) due to sorption to Fe(III) solids (Table 4). Similar results were obtained for the IUC system but with U(VI) reduction increasing at a slightly higher pH (FIG. 5d), likely due to FeCO₃ (siderite) formation. For the IUC system, FeCO₃-mediated reduction of U(VI) was not thermodynamically feasible at pH<9.2, as shown by line II of FIG. 5b.

TABLE 3
Uranium oxidation state in the IU and IUC systems
determined from XANES spectroscopy. Initial
concentrations of U(VI) in the IU and IUC systems were
0.21 and 0.2 mM, respectively. Estimated uncertainty of
oxidation state determinations is 10%.

| | Initial pH | Final pH | | |
|---|---|---|---|---|
| System | value | value | U(VI) % | U(IV) % |
| IU | 6.52 | 5.45 | 47 | 53 |
| | 10.77 | — | 3 | 97 |
| IUC | 6.39 | 6.28 | 63 | 37 |
| | 10.73 | — | 1 | 99 |

TABLE 4
Consumption ratios for soluble Fe(II) and
soluble U(VI) in the IU system

| | | | | |
|---|---|---|---|---|
| Start pH value | 5.74 | 6.49 | 7.20 | 7.77 |
| Final pH | 5.45 | 5.45 | 5.45 | 5.45 |
| Fe(II) removed | 0.09 | 0.14 | 0.14 | 0.08 |
| (mM) | | | | |
| U(VI) removed | 0.044 | 0.065 | 0.064 | 0.035 |
| (mM) | | | | |
| Ratio of Fe(II) | 2.06 | 2.15 | 2.19 | 2.29 |
| removed to | | | | |
| U(VI) removed | | | | |

Experimental results confirmed thermodynamic predictions regarding changes in U(VI) reduction as a function of pH. U(VI) reduction did not occur in the IU system for pH values less than 5.4 but did occur when the initial pH was greater than 5.4 (FIG. 5c). At higher initial values, AG for U(VI) reduction became more negative (FIG. 5a), enabling more extensive U(VI) reduction at equilibrium. At initial pH values above 8, soluble uranium concentrations decreased to very low levels (<10 μg/L, the detection limit) in both the IU and IUC systems. At high pH levels, (UO₂)₃(OH)₇⁻ and UO₂(CO₃)₃⁴⁻ was dominant but free energy changes were relatively insensitive to speciation: plots of 12 different combinations of reducing and oxidizing agents overlay one another (FIGS. 2a-f), indicating that different U(VI) species had consistent thermodynamic properties and that changes in speciation had relatively minor effects on the overall free energy change. Similarly, the exact composition of solid-phase products, assumed in this case to be amorphous UO₂ and Fe(OH)₃, had little effect on the predictive power of the thermodynamic calculations.

Rates of Uranium Reduction in the Iron-Uranium and Iron-Uranium-Carbonate Systems.

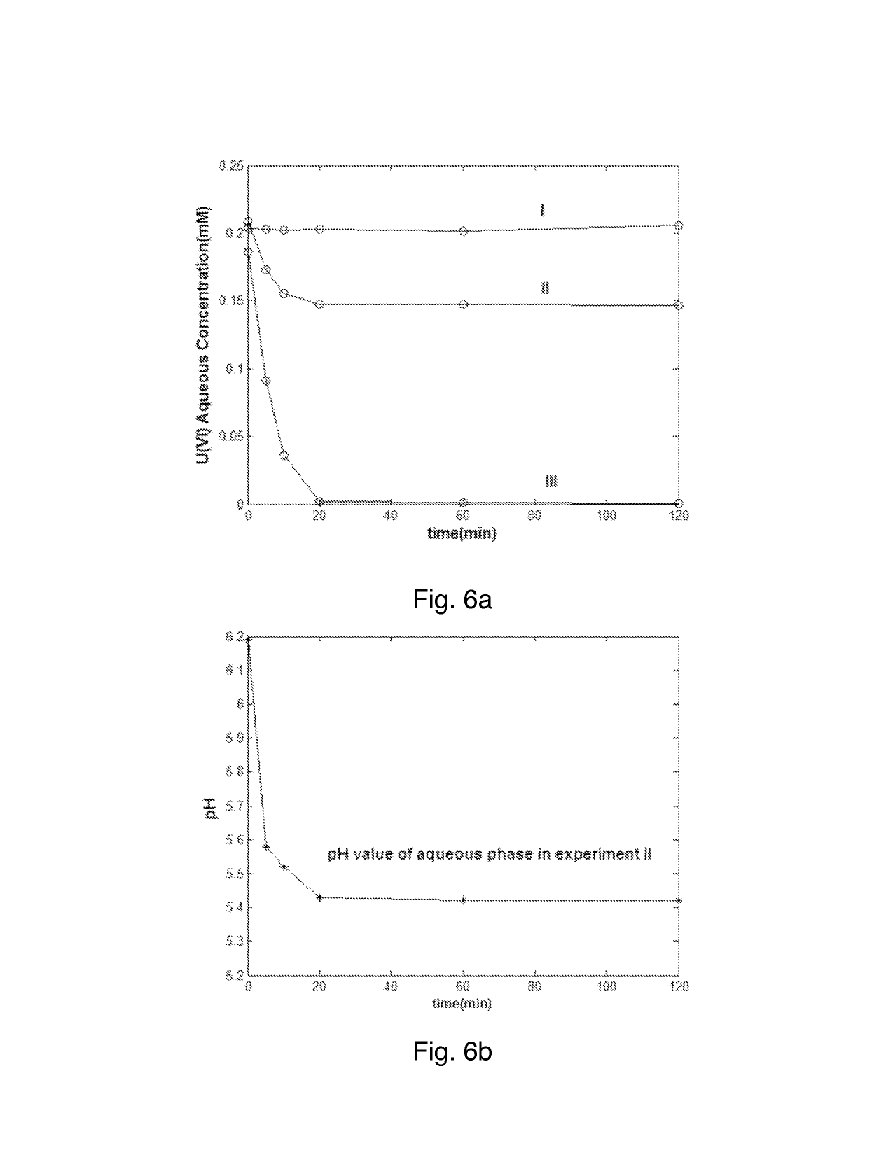

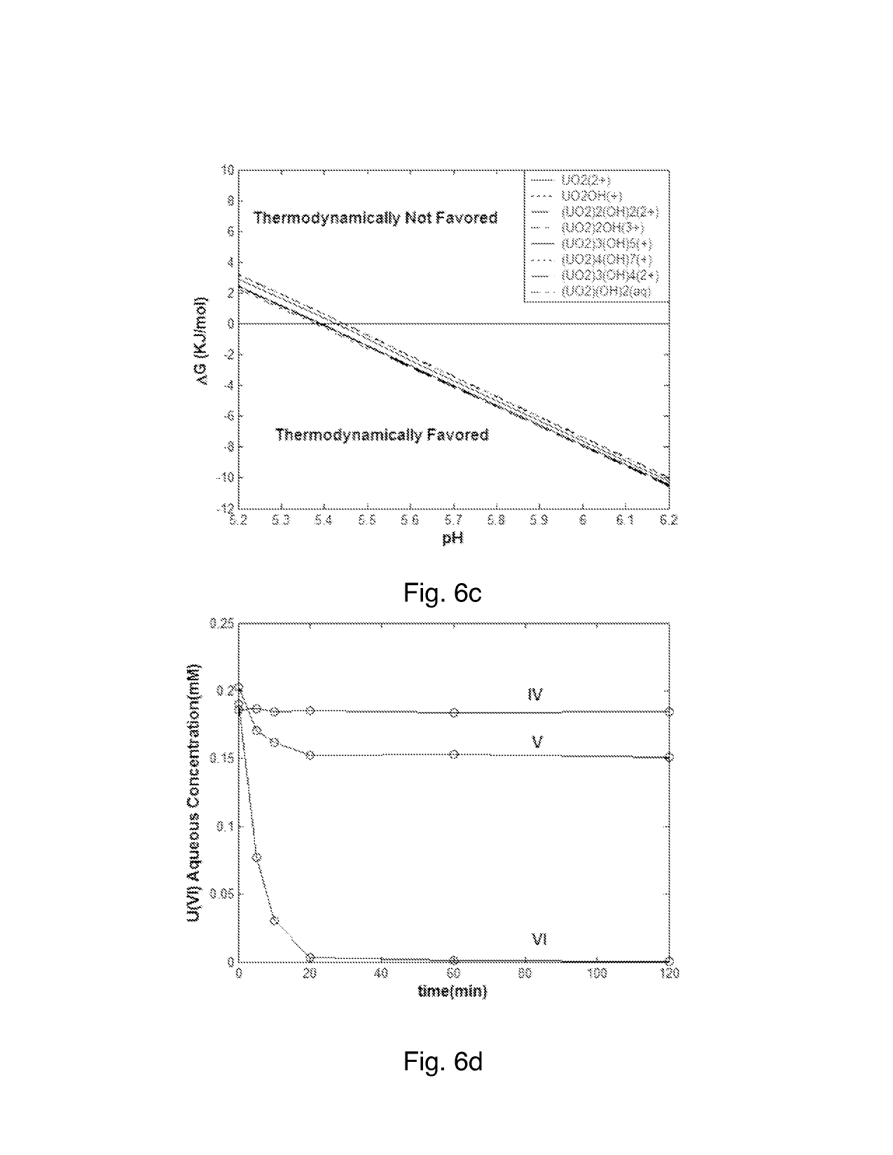

Kinetic measurements were performed at different pH values. FIGS. 6a-d show the results. FIG. 6a shows changes in U(VI) concentration in the IU system over time for initial pH values of 4.10 (line I), 6.19 (line II), and 8.79 (line III). FIG. 6b shows changes in pH in the IU system over time for initial pH values of 6.19. FIG. 6c shows changes in ΔG for different U(VI) species in the IU system over a pH range of 5.2-6.2, with initial concentrations of 0.2 mM for U(VI) and 1 mM for Fe(II). FIG. 6d shows changes in U(VI) concentration in the IUC system over time for initial pH values of 4.03 (line IV), 6.22 (line V), and 8.93 (line VI).

Reactions initiated in the IU system at a pH>5.4 proceeded in accordance with thermodynamic predictions: soluble U(VI) decreased and pH declined due to production of acidity. Reduction was rapid but decreased as the reaction advanced (FIGS. 6a-b), decreasing to zero at pH 5.4, the point at which the computed value for AG was zero (FIG. 6c). The reaction came to completion in just 20 min (FIG. 6a, curve II, and FIG. 6b). When the initial pH was 8.79 in the IU system and 8.93 in the IUC system, the same final pH resulted at equilibrium but essentially all of the soluble U(VI) was reduced to insoluble U(IV) (FIGS. 6a and 6d).

A specific example underscores the above generalizations. In the IU system at pH 6.19, (UO₂)₃(OH)₅⁺ is the dominant U(VI) species (FIG. 4a) and Fe²⁺ is the dominant Fe(II) species (FIG. 4c). The coupled reaction for U(VI) reduction and ferrous iron oxidation is

⅙(UO₂)₃(OH)₅⁺+Fe²⁺+13/6H₂O→Fe(OH)₃+½UO₂+13/6H⁺

From the above stoichiometry, 2 mol of Fe(II) is consumed and 4.3 mol of acidity produced for each mole of U(VI) reduced at pH 6.2. For the IU system, the measured stoichiometric ratios were ˜2.1 mol of U(VI) removed per mole of Fe(II) removed and ˜4.8 mol of acidity produced. As the reaction proceeded, Fe(II) and U(VI) levels fell and pH decreased. After pH decreased to the predicted equilibrium value of 5.4, no further decreases occurred in U(VI), Fe(II), or pH (FIG. 6a, line II; FIG. 6b). Similar results were obtained for the IUC system (FIG. 6d).

Oxidation State of Uranium in the Solid Phase.

XANES spectra for IU and IUC samples listed in Table 3 were fit by a linear combination of U(IV) and U(VI) standards. In both systems, samples in the pH range 10.7-10.8 were fully reduced to U(IV). Samples in the pH range 5.5-6.3 contained U(IV) and U(VI) in roughly equal proportions. The presence of U(VI) in these spectra is indicated by a slight shift of the absorbance maximum to higher energy and by the appearance of a peak in the XANES spectra at ca. 17,185 eV due to axial oxygen multiple scattering in the uranyl trans-dioxo cation.

### B4) Discussion

This work adds soluble Fe(II) to the expanding list of Fe(II) compounds that can reduce U(VI), including green rust, FeS, and magnetite. The following lines of evidence support this conclusion

(1) The initial reaction system contained soluble Fe(II) only. Disappearance of aqueous Fe(II) with concomitant disappearance of aqueous U(VI) and appearance of solid U(IV) are consistent with U(VI) reduction by soluble Fe(II) species. The ratio of Fe(II) removed to U(VI) removed increased from 2.06:1 at pH levels close to the predicted equilibrium pH to 2.29:1 at higher pH levels (Table 4) consistent with a two-electron transfer from soluble Fe(II) species to soluble U(VI) followed by increased adsorption of Fe(II) to Fe(III) solids as Fe(II) was oxidized.
(2) Equilibrium pH values predicted from thermodynamic calculations were confirmed experimentally: reduction of U(VI) occurred at pH values above the predicted equilibrium pH values, and no reduction occurred at pH values below the predicted values.
(3) The rates of U(VI) reduction decreased as pH of the solution decreased to the predicted equilibrium pH. This is consistent with a decreasing free energy gradient as the reaction approached equilibrium.
(4) XANES analyses confirmed U(IV) formation. Partial U(IV) formation occurred when the reaction was initiated at pH 6.5, and complete reduction occurred when the reaction was initiated at a pH of 10.8.

A useful perspective on our results is obtained from a pH-pe analysis of the IU system. If Fe²⁺ is the assumed electron donor, the half reaction for Fe²⁺ oxidation is

Fe²⁺+3H₂O→Fe(OH)₃+3H⁺+e⁻

The corresponding pe expression is

$${pe}_{{Fe}^{2 +}} = - 3 pH - log [ {Fe}^{2 +} ] - log ( exp ( - \frac{Δ {G}_{{Fe}^{2 +}}^{θ}}{RT} ) )$$

The half reactions for U(VI) reduction have the general form

aU(VI)+bH⁺+e−→½UO₂(am,hyd)+bH₂O

The corresponding pe expression is

$${pe}_{U ( VI )} = - b pH + a log [ U ( VI ) ] + log ( exp ( - \frac{Δ {G}_{U ( VI )}^{θ}}{RT} ) )$$

where values for a and b are indicated in Table 1.

Of interest are the multipliers for pH in the above pe expressions: the equation for Fe(III)/Fe(II) has a pH multiplier of 3, but pe equations for U(VI)/U(IV) have pH multipliers (i.e., b values) that are less than 2 for pH<8 (FIG. 4a and Table 1). Values of pe for Fe(III)/Fe(II) couples are therefore more sensitive to pH than those of the U(VI)/U(IV) couples.

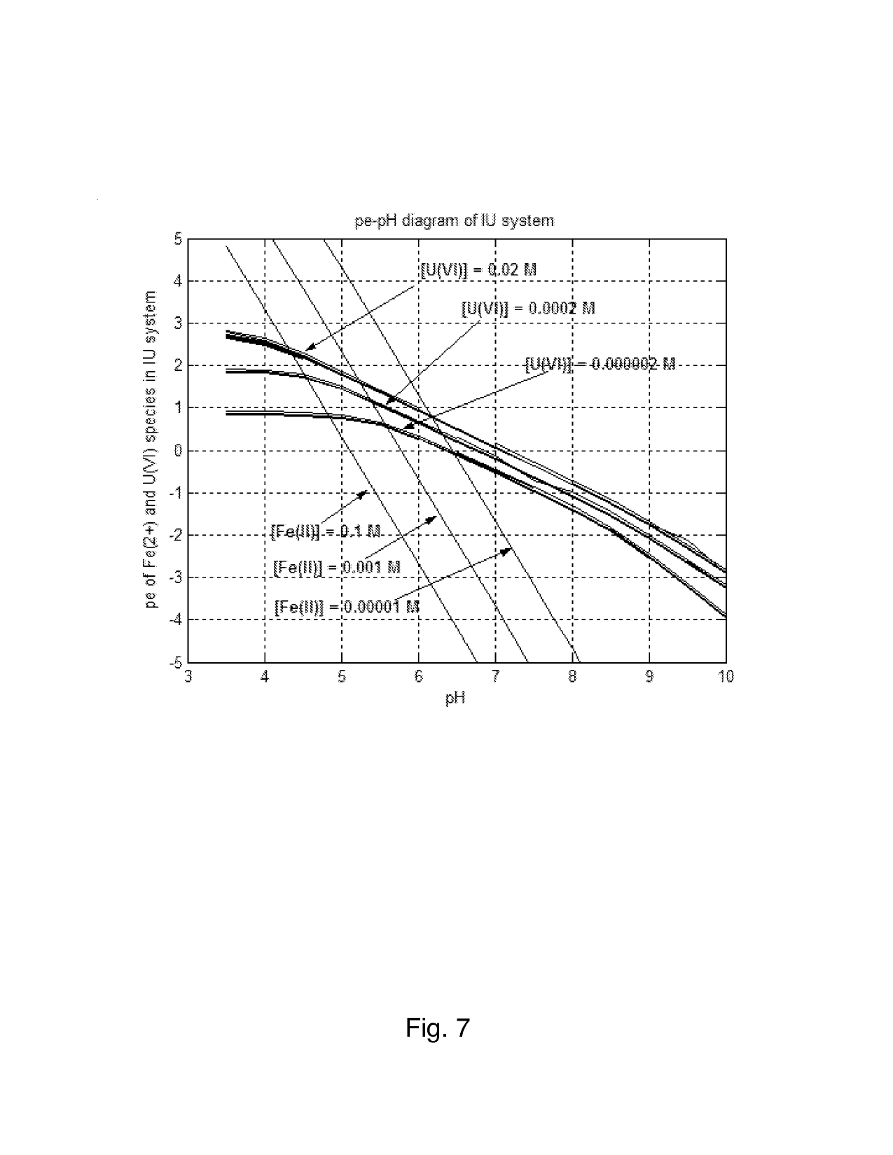

FIG. 7 illustrates this effect. As pH increases, pe for both couples decreases but the slopes of Fe(III)/Fe(II) pe-pH lines are steeper than the pe-pH lines of the U(VI)/U(IV) couples. Consequently, the lines for Fe(III)/Fe(II) cross the lines for U(VI)/U(IV) at equilibrium pH values that decrease with increasing concentrations of Fe(II).

A previous study (Liger et al., cited above) did not detect reduction of soluble U(VI) by soluble Fe(II), thereby making the present results somewhat surprising and unexpected. A detailed analysis of the Liger et al. work shows that the initial reactant and product concentrations used in some of their reported experiments were not favorable for U(VI) reduction (e.g., ΔG>0). Other experiments described by Liger et al. were subject to analytical problems due to fluorescence quenching by iron and/or sampling protocols that would not have detected a rapid decrease in U(VI). The present study avoided such concerns.

### C) Long-Term Stability Experiment

### C1) Introduction

As indicated above, the present approach relies on the concept that uranium can be sequestered in iron oxides or hydroxides, independent of its oxidation state. This is a surprising result, because conventional knowledge in the art suggests that U(IV) compounds can be sequestered, but that U(VI) compounds cannot be sequestered successfully. Thus, a direct experimental test of long term sequestration of U(VI) has been performed and the results follow

### C2) Materials and Methods

Stock Solutions.

Stock solutions were prepared in 160 ml anaerobic serum bottles with oxygen-free water under a helium headspace. The chemicals for preparing these stock solutions are analytical-grade or better: UO₂Cl₂, 10 mM; FeCl₂, 20 mM; HCl, 0.5M; NaOH, 0.2M. All these stock solutions are stored in an anaerobic glovebox (Coy Laboratory Products Inc.) filled with helium in the headspace. Iron(II) chloride tetrahydrate (99.99%) purity purchased from Sigma-Aldrich was used for preparation of stock solutions. Uranyl chloride was obtained from Johnson Matthey, Ward Hill, Mass.

Uranium(VI) Reduction and Reoxidation Through Shifting pH in the Iron-Uranium(IU) System.

This entire procedure of experiment is carried out in the anaerobic glovebox. A serum bottle sealed with butyl rubber stoppers was prepared with 90 mL oxygen-free deionized water under a helium headspace. Syringes were deployed to add the following stock solutions into the bottle in sequential order: 2 mL of the UO₂Cl₂ stock, 5 mL of the FeCl₂ stock, and 1 mL of HCl stock. The initial concentration of Fe(II) and U(VI) are 1.09 mM and 0.19 mM respectively with initial pH value of 2.24. The pH value will be increased by stepwise adding aliquots (0.02-0.5 mL) of NaOH stock until pH reaches 10.35. After this point, aliquots (0.02-0.4 mL) of HCl stock are added until pH reaches back to 2.68. Duplicate samples are extracted at each pH level. At pH>8, a green precipitate appeared and bottles were shaken well to obtain a well-mixed sample.

After collection of 25 samples at different pH levels, samples were centrifuged for 4 min at 1400 rpm in the glovebox. Centrate was removed by pipet and transferred to glass tubes containing 10 mL of anaerobic acidified deionized water (pH=2.1) and then assayed for Fe(II) and U(VI). Solids extracted at highest pH (10.35) was stored in a plastic screw-cap anaerobic centrifuge tube for future analysis by X-ray adsorption near-edge structure (XANES) spectroscopy.

Oxidation of Uranium in Iron Reduced Condition at High pH.

Like the initial reduction process we conducted in the above experiment, UO₂Cl₂,FeCl₂ and HCl stock solutions were added into anaerobic serum bottle to set up the reaction start point at thermodynamic infeasible region. Instead of sequentially adding NaOH aliquots, the solution was adjusted to pH=9.65 to trigger the reaction. Samples were extracted using syringe and the concentration of U(VI) were measured vs. time. After U(VI) concentration is not detectable in the aqueous phase, the stopper was removed and the reaction system was exposed to pure oxygen aeration for 20 minutes, after which, the serum bottle was encapsulated with pure oxygen in the headspace. The long term stability of the U(VI) was tested by extracting samples from the bottle to measure the U(VI) concentration every three months. After 500 days, solid sample was collected to conduct XANES analysis, and selected area diffraction was applied to detect the iron crystal.

Kinetics of Uranium Reduction by Fe(OH)₂ and Long Term Stability.

Initially, U(VI) is added to the prepared Fe(OH)₂ solution at pH=10.09 in an anaerobic serum bottle with helium in the headspace. Concentrations of U(VI) in aqueous phase were measured every four minutes by extracting samples from serum bottle using syringe. After concentration of U(VI) in the liquid phases is undetectable, the cap of the serum bottle is removed, and pure oxygen is applied to the reaction system for twenty minutes, after which the U(VI) concentrations in the liquid phases were measured. Then, the serum bottle was encapsulated again with pure oxygen in the headspace, and long term stability of uranium was tested every 100 days. After 500 days, the solid samples was collected for XANES analysis to detect the U(VI)/U(IV) ratio in the solid phase.

### C3) Results

Uranium(VI) Reduction and Reoxidation Through Shifting pH in the Iron-Uranium(IU) System.

According to the thermodynamic analysis of section B above, uranium reduction by Fe(II) in the IU system becomes thermodynamically feasible when pH>5.5. When pH>8.5, no response of the U(VI) in the liquid phase is detected, and when pH reaches 10.35, we trigger the reoxidation by decreasing the pH. The results of section B show that uranium reduction-oxidation by shifting the pH is reversible and once pH decreases to 8, the concentration of U(VI) began to increase from zero back to its original level.

Long Term Stability of U/Fe Oxides/Hydroxides.

The measured U(VI) (aq) decreases to undetectable level within 20 minutes. After this, a twenty-minute continuous pure oxygen aeration does not release the uranium to the liquid phase. Long term stability of the uranium has been observed in the solid phase for 500 days (i.e., measured aqueous uranium concentration remains undetectable over this time span). Transmission electron microscopy of the solid phase in this experiment is consistent with a layered structure of uranium and iron compounds (e.g., Fe₃O₄).

Oxidation State of Uranium in the Solid Phase.

XANES spectra for the solid phase of the above experiments were fit by a linear combination of U(VI) and U(IV) standards. Before aeration, the uranium in the solid phase is fully reduced to U(IV), and after the twenty minute oxygen aeration, the uranium is partially oxidized to U(VI) with a U(VI)/U(IV) ratio of 80/20. After 500 days, the U(VI) percentage goes to 92%, and U(IV) accounts about 7˜8% in both systems.

### C4) Discussion

The preceding results demonstrate the surprising result that uranium remediation does not require maintaining reducing conditions over the long term, as has typically been thought necessary. More specifically, we have shown long term sequestration of uranium in its U(VI) oxidation state, which has previously not been thought possible. This result provides important experimental support for the above-identified uranium remediation approaches.

1. A method for in situ remediation of uranium, the method comprising:
providing a remediation location having soluble uranium;
reducing the soluble uranium to a U(IV) oxidation state in situ;
providing iron in a Fe(II) oxidation state to the remediation location in situ;
oxidizing the Fe(II) and U(IV) to provide a sparingly soluble U(VI)-Fe(III) oxide or hydroxide in situ.

2. The method of claim 1, wherein the reducing the soluble uranium to a U(IV) oxidation state in situ comprises raising a pH of the remediation location.

3. The method of claim 2, wherein the raising a pH of the remediation location comprises releasing elemental iron in the release location, whereby uranium is reduced to the U(IV) oxidation state by hydrogen released in a Fe+2H₂O->Fe(II)+H₂+2OH⁻ reaction.

4. The method of claim 2, wherein the raising a pH of the remediation location comprises providing MgO to the remediation location, whereby the pH is raised by a MgO+H₂0->Mg(OH)₂ reaction.

5. The method of claim 2, wherein the reducing the soluble uranium to a U(IV) oxidation state is partial or substantially complete.

6. The method of claim 2, wherein the raising a pH of the remediation location comprises providing a carbonate solution to the remediation location.

7. The method of claim 1, wherein the providing iron in a Fe(II) oxidation state comprises facilitating metabolism of Fe(III) respiring bacteria that produce Fe(II) as a metabolism product, wherein the Fe(III) respiring bacteria are present in the remediation site.

8. The method of claim 1, wherein the providing iron in a Fe(II) oxidation state comprises providing a solution of an Fe(II) compound.

9. The method of claim 1, wherein the providing iron in a Fe(II) oxidation state comprises providing nanoparticles including elemental iron or a Fe(II) iron compound.

10. The method of claim 9, wherein the nanoparticles have a coating covering the elemental iron or the Fe(II) iron compound, wherein the coating dissolves or degrades in situ at the remediation location.

11. The method of claim 10, wherein the nanoparticles comprise the elemental iron, wherein release of the elemental iron into the remediation location leads to formation of iron in the Fe(II) oxidation state.

12. The method of claim 1, wherein the oxidizing the Fe(II) and U(IV) comprises allowing natural oxidation processes of the remediation location to provide the sparingly soluble U(VI)-Fe(III) oxide or hydroxide in situ.

13. The method of claim 1, wherein the oxidizing the Fe(II) and U(IV) comprises providing one or more oxidants to the remediation location.

14. The method of claim 13, wherein the one or more oxidants are selected from the group consisting of: O₂, H₂O₂, NO₂⁻ ions, NO₂⁻ ions, nitrous oxide, and bleach.
